(19) United States
(12) Patent Application Publication
(10) Pub. No.: US 2025/0255761 A1
(43) Pub. Date: Aug. 14, 2025

(54) JOYSTICK CONTROL SYSTEM AND A METHOD OF CONTROLLING A JOYSTICK

(71) Applicant: Mirza Faizan, Irving, TX (US)

(72) Inventors: Mirza Faizan, Irving, TX (US); Raahi S Jogani, Sunnyvale, TX (US); Sofia Sethuraman, Dallas, TX (US); Nadia Anisa Sethuraman, Dallas, TX (US); Aarish Salman Bhojani, Euless, TX (US); Zaid Marwat, Allen, TX (US); Hisham Ahmad, Allen, TX (US); Isha Agrawal, Plano, TX (US); Raed Sharib, Irving, TX (US); Sheza Asif, Parker, TX (US); Vihan Yerubandi, Southlake, TX (US); Abdul Salam Abubaker, Ajman (AE); Yusuf Abubaker, Ajman (AE); Noah Abubaker, Ajman (AE); Ashaz Haque, Patna (IN); Abdullah Hasani, Murphy, TX (US); Sheik Ahamed Azigar Ali, Frisco, TX (US)

(21) Appl. No.: 18/438,552

(22) Filed: Feb. 12, 2024

(51) Int. Cl. A61G 5/04; F16H 19/04; G06F 3/01; G06F 3/0338; G06F 3/0482

(52) U.S. Cl. CPC A61G 5/04; F16H 19/04; G06F 3/015; G06F 3/0338; A61G 2203/14; A61G 2203/20; A61G 2203/40; G06F 3/0482

(57) ABSTRACT

A joystick control system and a method of controlling a joystick of an apparatus is disclosed. The joystick control system includes one or more manipulator-arms, such that each of the one or more manipulator-arms is configured to engage with the joystick. Each of the one or more manipulator-arms is further configured to travel in an associated direction and cause a movement of the joystick along the associated direction. The joystick control system further includes an actuator mechanically coupled with each of the one or more manipulator-arms and configured to generate an action to cause each of the one or more manipulator-arms to travel in the associated direction. A controller is communicatively coupled with the actuator and is configured to generate an instruction to trigger the actuator to generate the action.

### TECHNOLOGICAL FIELD

The present disclosure relates generally to automated controlling a wheelchair. more particularly, the present disclosure relates to control systems and methods for controlling joysticks of wheelchairs.

### BACKGROUND

Paralysis, amputation, and other kinds of handicapping conditions may limit the capability of humans to perform certain tasks, such as those that require a joystick. Some examples of such tasks include operating a wheelchair, playing video games, etc. It is estimated that around 65 million people globally use a wheelchair on a daily basis. Further, as much as 8 percent of the total wheelchair users are paralyzed. Due to their condition, wheelchair users are often dependent on others in order to move around, even while using motorized wheelchairs. As such, these wheelchair users have little to no autonomy with respect to movement. The lack of autonomy greatly reduces the quality of life and often negatively impacts the mental health of these wheelchair users.

Motorized wheelchairs, for example, those powered by electric motors, are generally controlled by a joystick. Although these motorized wheelchairs require minimal manipulation through joysticks to control their operation. However, due to the above conditions, certain users may not be able to perform these manipulations using their hands.

There is, therefore, a need for solutions that allow the existing joystick-operated apparatuses, such as motorized wheelchairs, to be operated without using hands, and increasing the user's sense of independence.

### SUMMARY

According to one embodiment, a joystick control system is disclosed. The joystick control system includes one or more manipulator-arms, such that each of the one or more manipulator-arms is configured to engage with a joystick associated with an apparatus. Each of the one or more manipulator-arms is further configured to travel in an associated direction and cause a movement of the joystick along the associated direction. The joystick control system further includes an actuator mechanically coupled with each of the one or more manipulator-arms and configured to generate an action to cause each of the one or more manipulator-arms to travel in the associated direction. The joystick control system further includes a controller communicatively coupled with the actuator and configured to generate an instruction to trigger the actuator to generate the action. According to some embodiments, the actuator is an electric motor. The joystick control system may be configured to retro-fit on the joystick associated with the apparatus.

According to some embodiments, the one or more manipulator-arms include a first pair of manipulator-arms, such that each of the first pair of manipulator-arms is configured to travel in opposite directions, to cause a forward and a backward movement of the joystick. In addition, the one or more manipulator-arms further include a second pair of manipulator-arms, such that each of the second pair of manipulator-arms configured to travel in opposite directions and perpendicular to a direction of travel of each of the first pair of manipulator-arms, to cause a leftward and a rightward movement of the joystick.

According to some embodiments, the actuator is mechanically coupled with each of the one or more manipulator-arms via an associated gear assembly. Further, the gear assembly may include a rack configured to couple with an associated manipulator-arm of the one or more manipulator-arms. The gear assembly may further include a pinion configured to couple with the actuator and further configured to engage with the rack. The action generated by the actuator may cause a movement of the pinion. The movement of the pinion may be transferred to the rack and subsequently to the associated manipulator-arm, to cause the associated manipulator-arm to travel in the associated direction. According to some embodiments, the controller may generate the instruction to trigger the actuator, based on a signal received from an electroencephalography (EEG) device contacting a user.

In addition, the joystick control system further includes a display screen communicatively coupled to the controller and configured to display a menu of a plurality of selectable options to present a visual stimuli to the user. A response to the stimuli corresponding to a selectable option of the plurality of selectable options may be detected by the EEG device. The EEG device may generate the signal based on the response to the stimuli.

In some example embodiments, the apparatus is a motorized wheelchair. Further, the joystick control system may include a remote sensing device communicatively coupled with the controller. The remote sensing device is configured to dynamically detect a position of the motorized wheelchair relative to its surroundings and generate sensor data corresponding to the position of the motorized wheelchair relative to its surroundings. The controller generates the instruction to trigger the actuator, further based on the sensor data, to facilitate autonomous navigation for the motorized wheelchair. The controller may generate the instruction to trigger the actuator based on a spatial map of the surroundings of the motorized wheelchair, to facilitate autonomous navigation for the motorized wheelchair, wherein the spatial map is predefined. For example, the remote sensing device comprises a Light Detection and Ranging (LiDAR) sensor.

According to some embodiments, the joystick control system further includes a curved extendable arm configured to be positioned on a front side of the motorized wheelchair and an arm rest section of the motorized wheelchair. The display screen may be positioned on the curved extendable arm.

According to one embodiment, a method of controlling a joystick of an apparatus is disclosed. The method includes transmitting an instruction to an actuator to trigger the actuator to generate an action. The controller is communicatively coupled with the actuator, and the actuator is mechanically coupled with each of one or more manipulator-arms. Each of the one or more manipulator-arms is configured to engage with the joystick associated with the apparatus. The action generated by the actuator is to cause each of the one or more manipulator-arms to travel in an associated direction and cause the movement of the joystick along the associated direction.

In addition, the method may further include receiving a signal received from an electroencephalography (EEG) device contacting a user, and generating the instruction to trigger the actuator, based on the signal received from the EEG device.

In addition, the method may further include displaying, via a display screen communicatively coupled to the controller, a menu of a plurality of selectable options to present a visual stimuli to the user. A response to the stimuli corresponding to a selectable option of the plurality of selectable options is detected by the EEG device. The EEG device generates the signal based on the response to the stimuli.

According to some embodiments, the instruction to trigger the actuator is generated, further based on sensor data obtained from a remote sensing device communicatively coupled with the controller and the joystick of a motorized wheelchair. The remote sensing device may be configured to dynamically detect a position of the motorized wheelchair relative to its surroundings and generate the sensor data corresponding to the position of the motorized wheelchair relative to its surroundings to facilitate autonomous navigation for the motorized wheelchair. In addition, the instruction to trigger the actuator may be generated based on a spatial map for the surroundings of the motorized wheelchair to facilitate autonomous navigation for the motorized wheelchair. The spatial map may be predefined.

According to one embodiment, a non-transitory computer-readable storage medium having computer program code instructions stored therein is disclosed. The computer program code instructions, when executed by at least one processor, cause the at least one processor to: transmit an instruction to an actuator to trigger the actuator to generate an action, the controller being communicatively coupled with the actuator. The actuator may be mechanically coupled with each of one or more manipulator-arms. Each of the one or more manipulator-arms may be configured to engage with the joystick associated with the apparatus. The action generated by the actuator may cause each of the one or more manipulator-arms to travel in an associated direction and cause the movement of the joystick along the associated direction.

Still other aspects, features, and advantages of the invention are readily apparent from the following detailed description, simply by illustrating a number of particular embodiments and implementations, including the best mode contemplated for conducting the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of an environment for controlling a joystick of an apparatus, according to one embodiment.

FIG. 2 is a diagram of components of a joystick controlling system, according to one embodiment.

FIG. 3A is a diagram depicting a motorized wheelchair implementing a joystick, according to one embodiment.

FIG. 3B is a diagram depicting the motorized wheelchair implementing the joystick and fitted with the joystick control system, according to one embodiment.

FIG. 4 is a schematic diagram depicting the joystick control system, according to one embodiment.

FIGS. 5A-5B are drawings depicting a rear view and a front view, respectively, of the joystick control system, according to one embodiment.

FIG. 6 is a flowchart of a method for controlling a joystick of an apparatus, according to one embodiment.

FIG. 7 is a diagram of a chipset that can be used to implement an embodiment.

FIG. 8 is a diagram of a hardware that can be used to implement an embodiment.

FIG. 9 is a diagram of a mobile terminal (e.g., handset, vehicle, or part thereof) that can be used to implement an embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

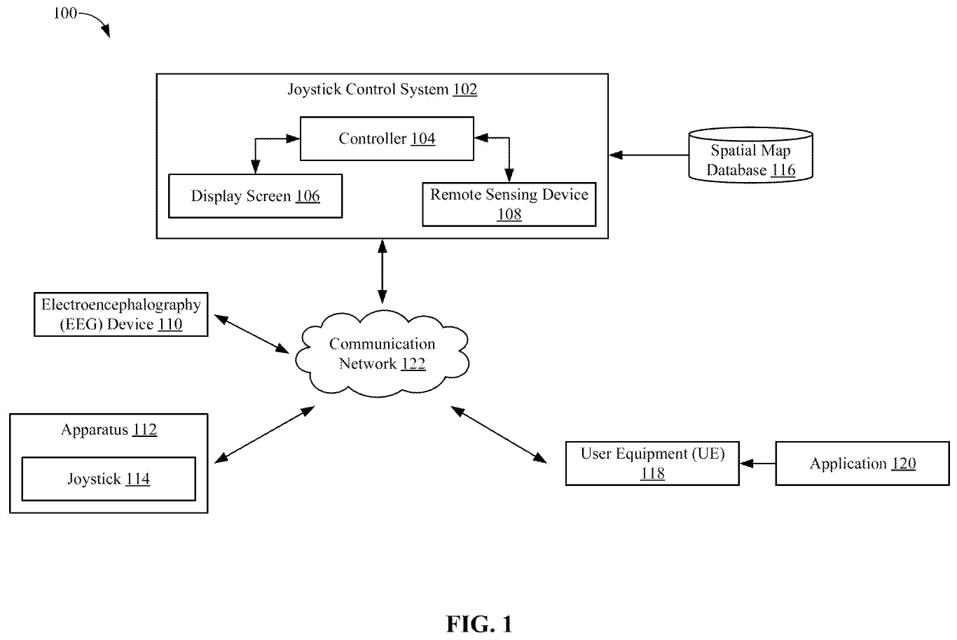

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 7, a brief description concerning the various components of the present disclosure will now be briefly discussed. Reference will be made to the figures showing various embodiments of a system for controlling a joystick of a wheelchair.

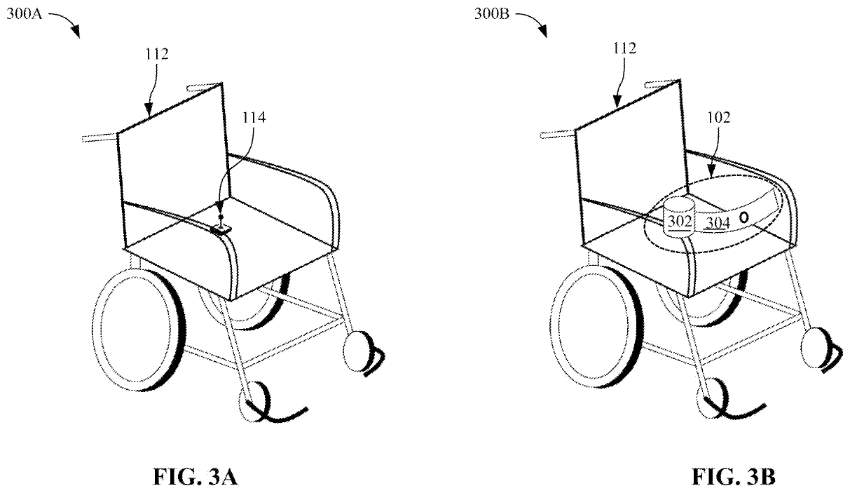

FIG. 1 is a diagram of an environment 100 for controlling a joystick of an apparatus, according to one embodiment. The environment 100 may include a joystick control system 102. The joystick control system 102 may include a controller 104, a display screen 106, and a remote sensing device 108. The environment 100 may further include an apparatus 112 implementing a joystick 114. For example, the apparatus 112 may include a motorized wheelchair, a video game console, etc. The controller 104 may be communicatively coupled with an actuator (as shown in FIG. 3) and configured to generate an instruction to trigger the actuator to generate an action. The display screen 106 may be communicatively coupled to the controller and configured to display a menu of a plurality of selectable options to present a visual stimuli to a user. The remote sensing device 108 may be communicatively coupled with the controller and communicatively coupled with the joystick 114, and configured to facilitate autonomous navigation for the apparatus 112, for example, a motorized wheelchair. The environment 100 may further include a spatial map database 116 that includes a predefined spatial map for the surroundings of the apparatus. The controller 104 may generate the instruction to trigger the actuator based on a spatial map, to facilitate autonomous navigation for the apparatus 112, i.e. the motorized wheelchair.

The environment 100 may further include an electroencephalography (EEG) device 110. For example, the EEG device 110 may be worn by a user who may not be in a position to manipulate the joystick 114 of the motorized wheelchair 112 (the terms “apparatus 112” and “motorized wheelchair 112” may have been used interchangeably in this disclosure) using his/her hands. Such a user, for example, may be a handicapped person or a patient suffering from paralysis of the hands. As such, a user who is unable to manipulate the joystick 114 of the motorized wheelchair 112 may not be able to control the movement of the motorized wheelchair 112. Therefore, to enable the user to control the movement of the motorized wheelchair 112, the user may be provided with the EEG device 110. As will be understood, the EEG device 110 may be worn over and contact the scalp of the head of the user. The EEG device 110 may contain a plurality of electrodes that may sense neural activity and generate a signal based on the sensed neural activity.

The environment 100 may further include a user equipment (UE) 118, an application 120, and a communication network 122.

In operation, the controller 104 may transmit an instruction to the actuator to trigger the actuator to generate an action. The controller 104 may receive a signal from the EEG device 110 contacting the user. To this end, the controller 104 may display, via the display screen 106 communicatively coupled to the controller 104, a menu of a plurality of selectable options to present a visual stimuli to the user. A response to the stimuli corresponding to a selectable option of the plurality of selectable options may be detected by the EEG device 110. The EEG device 110 may then generate the signal based on the response to the stimuli. The controller 104 may, therefore, generate the instruction to trigger the actuator, based on the signal received from the EEG device 110. Additionally, the instruction to trigger the actuator may be generated, based on sensor data obtained from the remote sensing device 108.

The remote sensing device 108 may be communicatively coupled with the controller 104 and the joystick 114 of the motorized wheelchair 112. In particular, the remote sensing device 108 may be configured to dynamically detect a position of the motorized wheelchair 112 relative to its surroundings and generate the sensor data corresponding to the position of the motorized wheelchair 112 relative to its surroundings, to facilitate autonomous navigation for the motorized wheelchair 112. Further, the instruction to trigger the actuator may be generated based on a spatial map (e.g. stored in the spatial map database 116) for the surroundings of the motorized wheelchair 112 to facilitate autonomous navigation for the motorized wheelchair 112. The controller 104 may be communicatively coupled with the actuator. Further, the actuator may be mechanically coupled with each of one or more manipulator-arms (as shown in FIG. 3) associated with the joystick control system 102. Each of the one or more manipulator-arms may be configured to engage with the joystick 114 associated with the apparatus 112. The action generated by the actuator may cause each of the one or more manipulator-arms to travel in an associated direction and cause the movement of the joystick 114 along the associated direction. The movement of the joystick 114 may therefore cause the movement of the motorized wheelchair 112 to facilitate autonomous navigation for the motorized wheelchair 112.

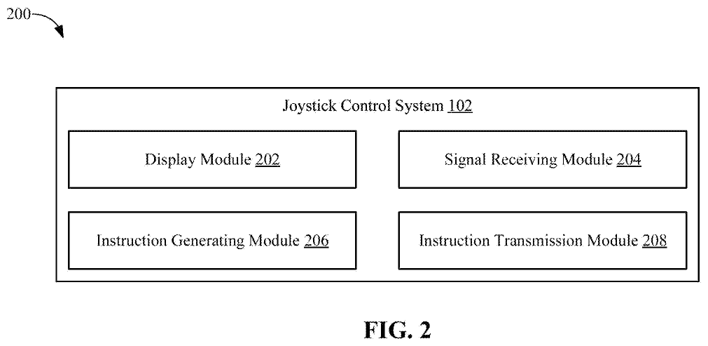

Additional components of the joystick control system 102 for controlling the joystick 114 of the apparatus 112 are described in FIG. 2.

FIG. 2 is a diagram 200 of components of the joystick control system 102 capable of controlling the joystick 114 of the apparatus 112, according to one embodiment. In one embodiment, as shown in FIG. 2, the joystick control system 102 includes one or more components for controlling the joystick 114 of the apparatus 112, according to the various embodiments described herein. It is contemplated that the functions of the components of the joystick control system 102 may be combined or performed by other components of equivalent functionality. As shown, in one embodiment, the joystick control system 102 includes a display module 202, a signal receiving module 204, an instruction generating module 206, and an instruction transmission module 208. The above presented modules and components of the joystick control system 102 can be implemented in hardware, firmware, software, or a combination thereof. Though depicted as a separate entity in FIG. 1, it is contemplated that the joystick control system 102 may be implemented as a module of any of the components of the environment 100 (e.g., a component of the UE 118, the application 120, and/or the like). In another embodiment, one or more of the modules 202-208 may be implemented as a cloud-based service, local service, native application, or combination thereof. The functions of the joystick control system 102 and modules 202-208 are discussed with respect to the figures below.

FIG. 3A is a diagram 300A depicting a motorized wheelchair 112 implementing a joystick 114, according to one embodiment. The motorized wheelchair 112 may be any conventionally known motorized wheelchair 112 with motorized movement function controlled by the joystick 114. A user may be able to control the movement of the motorized wheelchair 112, by manipulating the joystick 114 of the motorized wheelchair 112. For example, the motorized wheelchair 112 may implement a battery and an electric motor that powers the wheels of the motorized wheelchair 112 for movement. The joystick 114 may allow the user to control the moving or stopping and changing direction of the motorized wheelchair 112. However, certain users may not be able to manipulate the joystick 114 of the motorized wheelchair 112, to control the movement of the motorized wheelchair 112. For example, such users may include handicapped people or patients suffering from paralysis of the hands. To enable such users to manipulate the joystick 114 of the motorized wheelchair 112, the joystick control system 102 may be retro-fitted on the joystick 114 associated with the motorized wheelchair 112, the details of which are provided in FIG. 3B.

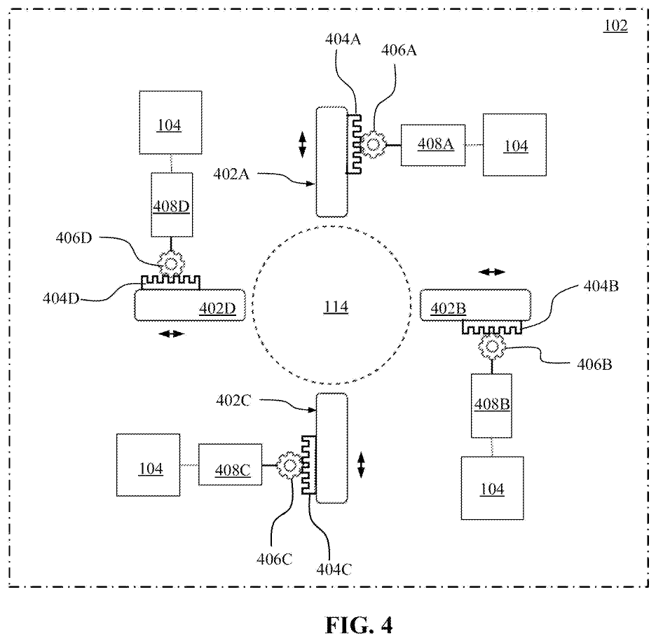

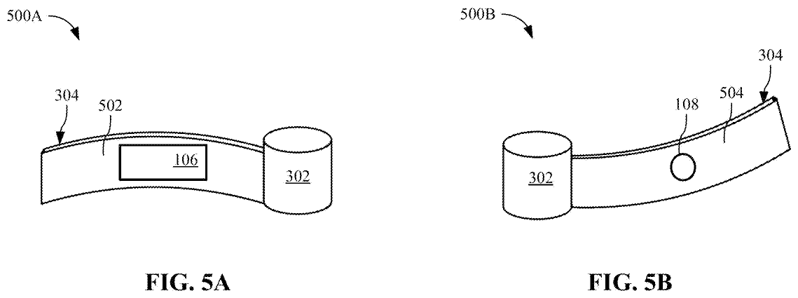

FIG. 3B is a diagram 300B depicting the motorized wheelchair 112 implementing the joystick 114 and fitted with the joystick control system 102, according to one embodiment. The joystick control system 102 may be configured to retro-fit on the joystick 114 associated with the existing motorized wheelchair 112. As such, the joystick control system 102 is easily attachable to the existing motorized wheelchair 112, by placing on top of the existing joystick 114. To this end, in some embodiments, as shown in FIG. 3B, the joystick control system 102 may include a housing 302 and an extendable arm 304. The housing 302 may be configured to fit on the joystick 114, to cause movement of the joystick 114. The extendable arm 304 may be positioned on a front side of the motorized wheelchair 112 and an arm rest section of the motorized wheelchair 112. The extendable arm 304 may be configured in a curved shape (as shown in FIGS. 5A-5B). The extendable arm 304 may include the display screen 106 on the rear side and the remote sensing device 108 on the front side of the extendable arm 304. Further, in some embodiments, the extendable arm 304 may be rotatably attached to the housing 302. As such, the extendable arm 304 may be configured to rotate about an axis between an open position and a closed position. In the closed position, as shown in FIG. 3B, the extendable arm 304 may be positioned in front of a user seated in the motorized wheelchair 112. In the open position, the extendable arm 304 may be rotated away to allow the user to get in or get out of the motorized wheelchair 112. Therefore, in order to allow the user to get in or get out of the motorized wheelchair 112, the extendable arm 304 may be configured in the open position, and once the user is seated, the extendable arm 304 may be rotated and configured into the closed position. Details about joystick control system 102 are provided along with FIG. 4, FIG. 5A and FIG. 5B.

FIG. 4 is a schematic diagram depicting the joystick control system 102, according to one embodiment. The diagram depicts the joystick control system 102 which is configured to retrofit on the joystick 114. The joystick 114 may be associated with the apparatus 112 which, for example, may include a motorized wheelchair, a video gaming console, etc.

The joystick control system 102 may include one or more manipulator-arms. Each of the one or more manipulator-arms may be configured to engage with the joystick 114 associated with the apparatus 112. Further, each of the one or more manipulator-arms may be configured to travel in an associated direction and cause a movement of the joystick 114 along the associated direction. For example, in some embodiments, as shown in FIG. 4, the joystick control system 102 may include a first pair of manipulator-arms 402A, 402C. Each of the first pair of manipulator-arms 402A, 402C may be configured to engage with the joystick 114 associated with the apparatus. Further, each of the first pair of manipulator-arms 402A, 402C may be configured to travel in opposite directions (as indicated by the arrows), to cause a forward and a backward movement of the joystick 114. In some embodiments, the joystick control system 102 may further include a second pair of manipulator-arms 402B, 402D. Each of the second pair of manipulator-arms 402B, 402D may be configured to engage with the joystick 114 associated with the apparatus 112. Further, each of the second pair of manipulator-arms 402B, 402D may be configured to travel in opposite directions (as indicated by the arrows), to cause a leftward and a rightward movement of the joystick 114.

As such, when the joystick control system 102 is fitted to the motorized wheelchair 112, the one or more manipulator-arms 402A, 402B, 402C, 402D are oriented at 90° to each other, around the joystick 114. This allows any direction of movement (forward-backwards and sideways) to be generated as a vector sum of the manipulator-arms.

As mentioned above, the joystick control system 102 may include an actuator mechanically coupled with each of the one or more manipulator-arms 402A, 402B, 402C, 402D. The actuator may be configured to generate an action to cause each of the one or more manipulator-arms 402A, 402B, 402C, 402D to travel in the associated direction. By way of an example, the actuator may be an electric motor. As shown in FIG. 4, in some embodiments, the joystick control system 102 may include a first actuator 408A mechanically coupled with the manipulator-arm 402A, a second actuator 408B mechanically coupled with the manipulator-arm 402B, a third actuator 408C mechanically coupled with the manipulator-arm 402C, and a fourth actuator 408D mechanically coupled with the manipulator-arm 402D.

It should be noted that, in some alternative embodiments, the joystick control system 102 may include a single actuator that may be mechanically coupled to each of the manipulator-arms 402A, 402B, 402C, 402D. In other words, in such embodiments, the functionalities of the first actuator 408A, the second actuator 408B, the third actuator 408C, and the fourth actuator 408D may be performed by a single actuator.

In some other embodiments, the joystick control system 102 may include an actuator that may be mechanically coupled to each of the first pair of manipulator-arms 402A, 402C. As such, in such embodiments, the functionalities of the first actuator 408A and the third actuator 408C may be performed by a single actuator. Further, the joystick control system 102 may include another actuator that may be mechanically coupled to each of the second pair of manipulator-arms 402B, 402D. As such, the functionalities of the second actuator 408B and the fourth actuator 408D may be performed by a single actuator.

In some embodiments, the actuator may be mechanically coupled with each of the one or more manipulator-arms 402A, 402B, 402C, 402D via an associated gear assembly. In particular, for example, the gear assembly may include a rack configured to couple with an associated manipulator-arm of the one or more manipulator-arms 402A, 402B, 402C, 402D, and a pinion configured to couple with the actuator and further configured to engage with the rack. The action generated by the actuator may cause a movement of the pinion. Further, the movement of the pinion may be transferred to the rack and subsequently to the associated manipulator-arm, to cause the associated manipulator-arm to travel in the associated direction. In an example embodiment, as shown in FIG. 4, each of the one or more manipulator-arms 402A, 402B, 402C, 402D is mechanically coupled with an associated actuator via an associated gear assembly, such that each associated gear assembly includes a rack and a pinion.

In particular, the manipulator-arm 402A may be mechanically coupled with the first actuator 408A via an associated gear assembly which includes a rack 404A and a pinion 406A. The rack 404A may be configured to couple with the associated manipulator-arm 402A. For example, the rack 404A may be attached to the associated manipulator-arm 402A, via welding, fasteners, etc. Alternatively, the rack 404A may be formed into the associated manipulator-arm 402A. The pinion 406A may be configured to couple with the associated first actuator 408A. Further, the pinion 406A may be configured to engage with the rack 404A. As will be appreciated by those skilled in the art, the rack 404A may include a set of teeth aligned linearly and the pinion 406A may include a set of teeth aligned along a circular periphery. Further, the sets of teeth of the rack 404A and the pinion 406A may have similar shape and size, to allow the rack 404A and the pinion 406A to engage and transfer motion there between. As such, when the pinion 406A is imparted rotary motion, the same may be transferred to the rack 404A via the sets of teeth to thereby impart a linear motion to the rack 404A.

As mentioned above, the first actuator 408A may be an electric motor that generates a rotary action. Therefore, the rotary action generated by the first actuator 408A may cause a rotary movement of the pinion 406A, and the rotary movement of the pinion 406A may be transferred to the rack 404A, and subsequently to the associated manipulator-arm 402A. As a result, the associated manipulator-arm 402A is caused to travel linearly in the associated direction.

Similarly, the manipulator-arm 402B may be mechanically coupled with the second actuator 408B via an associated gear assembly which includes a rack 404B and a pinion 406B; the manipulator-arm 402C may be mechanically coupled with the third actuator 408C via an associated gear assembly which includes a rack 404C and a pinion 406C; and the manipulator-arm 402D may be mechanically coupled with the fourth actuator 408D via an associated gear assembly which includes a rack 404D and a pinion 406D. Further, the gear assemblies associated with the manipulator-arms 402B, 402C, 402D may operate in the same fashion as the gear assembly associated with the manipulator-arm 402A, as described above. Further, it should be noted that the above gear assembly comprising the rack and pinion is only one of example implementations. It may be possible to use another type of gear assembly or another power transferring mechanism in place of the above gear assembly.

Further, as mentioned above, the joystick control system 102 may further include the controller communicatively coupled with the actuator and configured to generate an instruction to trigger the actuator to generate the action. For example, as shown in FIG. 4, the joystick control system 102 may include the controller 104 which may be communicatively coupled with each of the first actuator 408A, the second actuator 408B, the third actuator 408C, and the fourth actuator 408D. As such, a single controller 104 may be provided. Further, it should be noted that, in some alternative embodiments, a dedicated controller 104 may be provided for each of the first actuator 408A, the second actuator 408B, the third actuator 408C, and the fourth actuator 408D. The controller 104 may be configured to generate an instruction to trigger the actuators 408A, 408B, 408C, 408D to generate the action, in order to cause the movement of the joystick 114.

In some embodiments, the controller 104 may generate the instruction to trigger the actuators 408A, 408B, 408C, 408D, based on a signal received from the electroencephalography (EEG) device 110 contacting a user. As mentioned above, the EEG device 110 may be worn by a user who may not be in a position to manipulate the joystick 114 using his/her hands. As such, a user who is unable to manipulate the joystick 114 of the motorized wheelchair 112 may not be able to control the movement of the motorized wheelchair 112. To enable such a user to control the movement of the motorized wheelchair 112, the user may be provided with the EEG device 110 which may be worn over and contact the head of the user. The EEG device 110 may contain a plurality of electrodes that may sense neural activity and generate a signal based on the sensed neural activity.

The EEG device 110 may provide for a brain-computer interface (BCI) that allows for bidirectional communication through brain-to-computer connection. The BCI enables direct connections between the brain of the user and a controller (i.e. computer), without using existing input/output devices, such as audio and video devices. Accordingly, using BCI, decision making resulting from the brain's information processing is transmitted to the controller via the EEG device 110. When the user thinks and determines without using languages or physical behaviors, the BCI enables the user to provide instructions to the computer to execute corresponding commands. As such, BCI implemented through the EEG device 110 may allow the users to manipulate the joystick 114 of the motorized wheelchair 112, to thereby control the movement of the motorized wheelchair 112, without using a keyboard or a mouse. The controller 104 may be configured to receive signals from the EEG device 110 and control the joystick 114 accordingly. The controller 104 may be further configured to use incremental path planning algorithms to navigate a spatial map built using remote sensing sensors, such as Light Detection and Ranging (LiDAR) sensor.

FIGS. 5A-5B are drawings 500A, 500B depicting a rear view and a front view, respectively, of the joystick control system 102, according to one embodiment. As mentioned above, the joystick control system 102 may include the housing 302 and the extendable arm 304. As shown in FIG. 5A, the joystick control system 102 may include the display screen 106 which may be positioned on a rear side (i.e., inner side) 502 of the extendable arm 304. The joystick control system 102 may further include the controller 104 which may be positioned either in the housing 302 or the extendable arm 304. The display screen 106 may be communicatively coupled to the controller 104. The display screen 106 may be configured to display a menu of a plurality of selectable options to present a visual stimuli to the user.

By way of an example, the display screen 106 may be configured to display at least one selectable option, such that each of the at least one selectable option is displayed at a predetermined display frequency with respect to the other selectable options. In an example, a correspondence is determined between the brainwave state measurement and the display frequency of the at least one selectable option. One of the plurality of selectable options may present a visual stimuli to the user that may be detected by the EEG device 110. In particular, for example, the display screen may display a menu of options that include various destination locations for the user to select from-these destination locations may include a bedroom, a bathroom, a living room, a garden area, etc., such that the location information of each of these destinations is already recorded in the spatial map database 116. So, when the user is wishing to go to the bedroom, an option of “bedroom” displayed on the display screen 106 may lead to steady state visually evoked potential (SSVEP) in the brain of the user. As will be appreciated by those skilled in the art, the SSVEP is a quantifiable fluctuation of electrical activity that occurs in the brain in response to a specific visual stimuli that is measurable using an EEG device 110. As such, a specific SSVEP corresponding to an option from the plurality of selectable option helps in determining the option selected by the user. The EEG device 110 may measure the SSVEP corresponding to the selected option, using bio-signal sensors of the EEG device 110.

In some embodiments, when an option flashes on the display screen 106 at a certain frequency, that frequency (i.e. strength of frequency) can be detected by the brain of the user. This detection can then be used to select the options. For example, if several images (i.e. options) on the display screen 106 are flashing at different frequencies from one another, and the user looks at one of the images indicating an interest in one of the options, the EEG device 110 may determine this interest by detecting the frequency at which the option is flashing. In another example, if there are two options—option A (e.g. bedroom) and option B (e.g. living room)—on the display screen 106, and the option A is flashing at 7 Hertz (Hz) and the option B at 5 Hz, and a steady 5 Hz wave is detected by the EEG device 110, then it can be determined that the user was interested in the option B. The EEG device 110 may, therefore, be configured to conclude the user wishes to select option B, i.e. the user wishes to go to living room.

In some embodiments, a selection of an option from the menu of selectable options may be obtained by applying a Fourier Transform and finding the peak frequency on set windows of the signal. In some example embodiments, the menu option may be selected by applying a Fourier Transform and finding the peak frequency on set windows of the signal. If the frequency of the peak matches the one associated with an option, then the option selection may be confirmed. The stimuli and options may be displayed on the display screen 106 and may be controlled by the controller 104. Once the option is selected, a spatial map may be selected from the spatial map database 116. Alternatively, the options may include “forwards”, “backwards”, “left”, and “right” movements, in order to perform manual control over the motorized wheelchair 112.

Once the EEG device 110 has determined the selection from the user, the EEG device 110 may generate a signal which may be transmitted to the controller 104. To this end, the controller 104 may be configured to communicatively couple with the EEG device 110. The controller 104 may connect with the EEG device 110 over the communication network 122. For example, the communication network 122 may be a short-range wireless connection, such as Bluetooth or Bluetooth Low Energy (BLE). EEG device 110. The signal generated by the EEG device 110 may be transmitted to the controller 104, over the communication network 122.

As shown in FIG. 5B, the joystick control system 102 may further include the remote sensing device 108 which may be mounted on a front side (i.e., outer side) 504 of the extendable arm 304. The remote sensing device 108, for example, may include a Light Detection and Ranging (LiDAR) sensor. The remote sensing device 108 may be communicatively coupled with the controller 104. As mentioned above, the menu of options that are displayed to the user via the display screen 106 may include various destination locations (e.g. a bedroom, a bathroom, a living room, a garden area, etc.) for the user to select from. Once the signal is generated by the EEG device 110 corresponding to a selected option (i.e. a destination location), the remote sensing device 108 may navigate the motorized wheelchair 112 to the destination location. To this end, the remote sensing device 108 may be configured to dynamically detect a position of the motorized wheelchair 112 relative to its surroundings. Further, the remote sensing device may be configured to generate sensor data corresponding to the position of the motorized wheelchair 112 relative to its surroundings. The sensor data generated by the remote sensing device 108 is transmitted to the controller 104 which may generate the instruction to trigger the actuator based on the sensor data, to facilitate autonomous navigation for the motorized wheelchair 112.

In some embodiments, as mentioned above, in order to facilitate autonomous navigation for the motorized wheelchair 112, a spatial map for the surroundings of the motorized wheelchair 112 may be used. As such, the controller 104 may generate the instruction to trigger the actuator based on the spatial map for the surroundings of the motorized wheelchair 112. The spatial map, for example, may be predefined and stored in the spatial map database 116. The spatial map may include a local map data for a geographic region in which the motorized wheelchair 112 is to operate.

In order to facilitate autonomous navigation for the motorized wheelchair 112, the controller 104 may receive the sensor data from the remote sensing device 108 and the spatial data from the spatial map database 116. The controller 104 may, therefore, autonomously navigate the motorized wheelchair 112 based on the generate sensor data and the spatial map. In other words, the spatial map may be defined as a trajectory to be followed for reaching the destination location, while the remote sensing device 108 guides the motorized wheelchair 112, in real-time, to the destination location. In particular, the remote sensing device 108 may detect the current location and the obstacles in or along the trajectory to be followed by the motorized wheelchair 112, during the navigation.

Therefore, as shown in FIG. 5B, the remote sensing device 108 may be positioned on the front side (i.e., outer side) 504 of the extendable arm 304 of the joystick control system 102, to enable maximum visibility for the remote sensing device 108. However, it should be noted that, in alternate embodiments, the remote sensing device 108 may be positioned at any other location as well, without deviating from the scope of the present disclosure. Moreover, the remote sensing device 108 may not be limited to a LiDAR sensor and may include any other sensor known in the art that is capable of providing the navigation functionality as above.

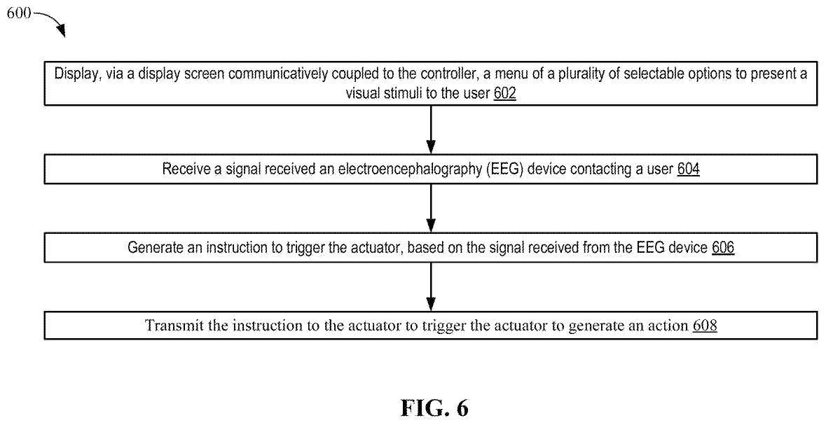

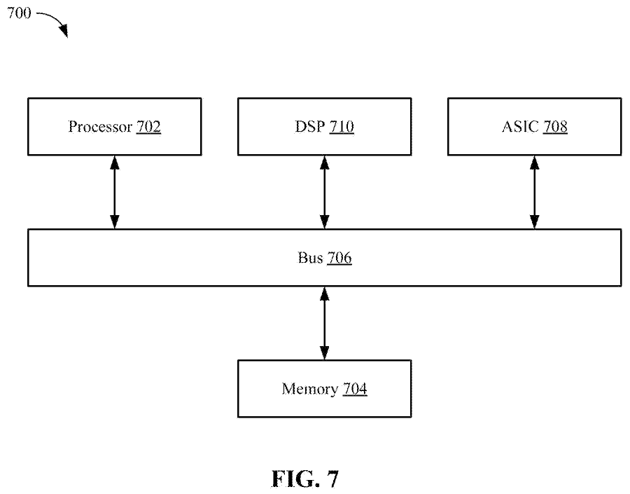

FIG. 6 is a flowchart of a method 600 of controlling the joystick 114 of the apparatus 112, according to one embodiment. In various embodiments, the controller 104 and/or any of the modules 202-208 may perform one or more portions of the method 600 and may be implemented in, for instance, a computer system including a processor and a memory as shown in FIG. 7. As such, the controller 104 and/or any of the modules 202-208 may provide means for accomplishing various parts of the method 600, as well as means for accomplishing embodiments of other processes described herein in conjunction with other components of the environment 100. Although the method 600 is illustrated and described as a sequence of steps, it is contemplated that various embodiments of the method 600 may be performed in any order or combination and need not include all of the illustrated steps.

At step 602, a menu of a plurality of selectable options may be displayed, via the display screen 106, to present a visual stimuli to the user. The step 602, for example, may be performed by the display module 202 of the joystick control system 102. The display screen 106 may be communicatively coupled to the controller 104. A response to the stimuli corresponding to a selectable option of the plurality of selectable options may be detected by the EEG device 110. The EEG device 110 may generate a signal based on the response to the stimuli. For example, the display screen 106 may display a menu of options that include various destination locations for the user to select. Examples of these destination locations may include, but are not limited to, a bedroom, a bathroom, a living room, a garden area, etc. For example, the location information of each of these destinations is already recorded in the spatial map database 116.

At step 604, a signal may be received from the EEG device 110 contacting a user. The step 604, for example, may be performed by the signal receiving module 204 of the joystick control system 102. A response to the stimuli (of step 602) corresponding to a selectable option of the plurality of selectable options is detected by the EEG device 110. The EEG device 110 may generate the signal based on the response to the stimuli. Continuing with the above example, when the user is wishing to go to the bedroom, an option of “bedroom” displayed on the display screen 106 may lead to SSVEP in the brain of the user. A specific SSVEP corresponding to an option from the plurality of selectable option helps in determining the option selected by the user. The EEG device 110 may measure the SSVEP corresponding to the selected option, using bio-signal sensors. Further, in some embodiments, when an option flashes on the display screen 106 at a certain frequency, that frequency can be detected by the brain of the user, and the detection can then be used to select the option. The menu option may be selected by applying a Fourier Transform and finding the peak frequency on set windows of the signal. If the frequency of the peak matches the one associated with an option, then the option selection is confirmed. Once the EEG device 110 has determined the selection from the user, the EEG device 110 may generate the signal which may be transmitted to the controller 104.

At step 606, the instruction to trigger the actuator may be generated, based on the signal received from the EEG device 110. The step 606, for example, may be performed by the instruction generating module 206 of the joystick control system 102. Additionally, in some embodiments, the instruction to trigger the actuator may be generated, further based on sensor data obtained from the remote sensing device 108. As shown in FIG. 5B, the remote sensing device 108 which may be mounted on the front side (i.e., outer side) 504 of the extendable arm 304 of the joystick control system 102. Once the signal is generated by the EEG device 110 corresponding to a selected option (i.e. a destination location), thereafter, the remote sensing device 108 may navigate the motorized wheelchair 112 to the destination location. To this end, the remote sensing device 108 may dynamically detect a position of the motorized wheelchair 112 relative to its surroundings. Further, the remote sensing device may generate the sensor data corresponding to the position of the motorized wheelchair 112 relative to its surroundings. The sensor data generated by the remote sensing device 108 is transmitted to the controller 104 which may generate the instruction to trigger the actuator based on the sensor data, to facilitate autonomous navigation for the motorized wheelchair 112. Further, in some embodiments, in order to facilitate autonomous navigation for the motorized wheelchair 112, a spatial map for the surroundings of the motorized wheelchair 112 may be used. The spatial map may include a local map data for a geographic region in which the motorized wheelchair 112 is to operate, and may be predefined and stored in the spatial map database 116. The controller 104 may generate the instruction to trigger the actuator based on the spatial map for the surroundings of the motorized wheelchair 112 to generate an action.

At step 608, the instruction may be transmitted to an actuator to trigger the actuator to generate an action. The step 608, for example, may be performed by the instruction transmission module 208 of the joystick control system 102. As shown in FIG. 4, the joystick control system 102 may include an actuator mechanically coupled with each of the one or more manipulator-arms 402A, 402B, 402C, 402D. The actuator may be configured to generate an action to cause each of the one or more manipulator-arms 402A, 402B, 402C, 402D to travel in the associated direction. In some example embodiments, the actuator may be an electric motor. Further, the joystick control system 102 may include a dedicated actuator for each of the one or more manipulator-arms 402A, 402B, 402C, 402D. In some alternative embodiments, the joystick control system 102 may include a single actuator that may be mechanically coupled to each of the manipulator-arms 402A, 402B, 402C, 402D. Further, in some other embodiments, the joystick control system 102 may include an actuator that may be mechanically coupled to each of the first pair of manipulator-arms 402A, 402C, and another actuator that may be mechanically coupled to each of the second pair of manipulator-arms 402B, 402D.

Each of the one or more manipulator-arms may be configured to engage with the joystick 114 associated with the apparatus 112, and travel in an associated direction and cause a movement of the joystick 114 along the associated direction. For example, the first pair of manipulator-arms 402A, 402C may be configured to travel in opposite directions (as indicated by the arrows), to cause a forward and a backward movement of the joystick 114. Further, the second pair of manipulator-arms 402B, 402D may be configured to travel in opposite directions (as indicated by the arrows), to cause a leftward and a rightward movement of the joystick 114. In some embodiments, the actuator may be mechanically coupled with each of the one or more manipulator-arms 402A, 402B, 402C, 402D via an associated gear assembly. For example, the gear assembly may include a rack configured to couple with an associated manipulator-arm of the one or more manipulator-arms 402A, 402B, 402C, 402D, and a pinion configured to couple with the actuator and further configured to engage with the rack. The action generated by the actuator may cause a movement of the pinion. Further, the movement of the pinion may be transferred to the rack and subsequently to the associated manipulator-arm, to cause the associated manipulator-arm to travel in the associated direction. The actuator may be an electric motor that generates a rotary action. Therefore, the rotary action generated by the actuator may cause a rotary movement of the pinion, and the rotary movement of the pinion may be transferred to the rack, and subsequently to the associated manipulator-arm. As a result, the associated manipulator-arm is caused to travel linearly in the associated direction.

Returning to FIG. 1, as shown, the environment 100 includes the controller 102. In one embodiment, the controller 102 has connectivity over the communication network 122 to a services platform that provides the one or more services that can use the obtained sensor data for downstream functions. By way of example, the service may be third party services and include but is not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the service may use the output of the controller 102 to provide services such as navigation, mapping, other location-based services, etc. to the UE 118, the applications 120, and/or other client devices. In one embodiment, the service platform may act as a content provider.

In one embodiment, the controller 102 may include multiple interconnected components. The controller 102 may be connected to multiple servers, intelligent networking devices, computing devices, components, and corresponding software for controlling the joystick 114, according to the various embodiments described herein. In addition, it is noted that the controller 102 may be a separate entity of the environment 100, or included within components of the UE 118.

In one embodiment, the UE 118 may execute software applications 120 to use the set of features or other data derived there from according to the embodiments described herein. By way of example, the applications 120 may also be any type of application that is executable on the UE 118, such as autonomous driving applications, routing applications, mapping applications, location-based service applications, navigation applications, device control applications, content provisioning services, camera/imaging application, media player applications, social networking applications, calendar applications, and the like. In one embodiment, the applications 120 may function as a client for the controller 102 and perform one or more functions associated with generation of the set of features alone or in combination with the controller 102.

By way of example, the UE 118 are or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 118 can support any type of interface to the user (such as “wearable” circuitry, etc.). In one embodiment, the UE 118 may be associated with or be a component of a vehicle or any other device. In one embodiment, the UE 118 is configured with various sensors for controlling the joystick 114 of the apparatus 112, related geographic data, etc.

In one embodiment, the communication network 122 of the environment 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the controller 102, and/or the UE 118 may communicate with each other and other components of the environment 100 using well known, new or still developing protocols. In this context, a protocol includes a set of rules defining how the network nodes within the communication network 122 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

The processes described herein for generating instructions to cause the wheelchair to perform an action may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

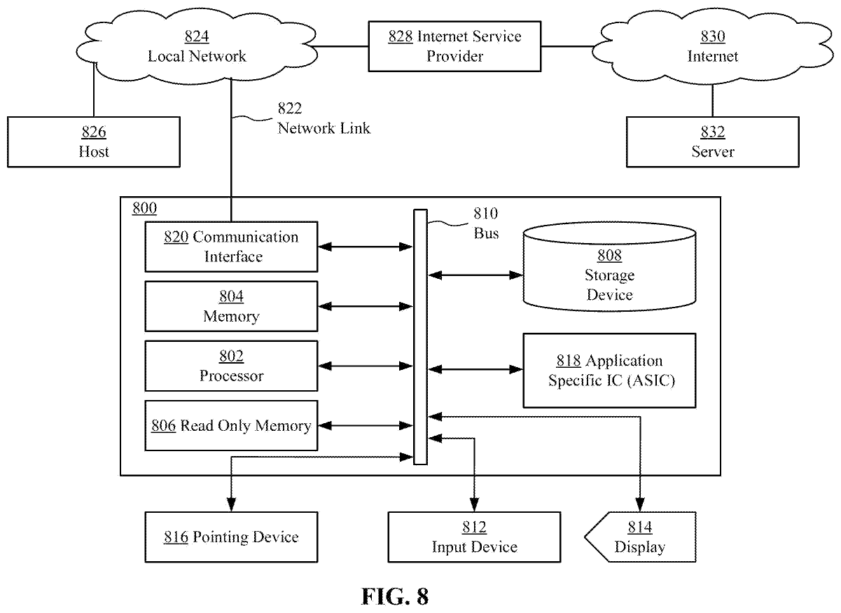

FIG. 7 is a diagram of a chip set 700 that can be used to implement an embodiment. The chip set 700 is programmed to control the joystick 114 of the apparatus 112 as described herein and includes, for instance, the processor and memory components are described with respect to FIG. 8 and FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 702 for passing information among the components of the chip set 700. A processor 704 has connectivity to the bus 702 to execute instructions and process information stored in, for example, a memory 706. The processor 704 may include one or more processing cores with each core configured to perform independently. A multi-core processor enables multiprocessing within a single physical package. Examples of a multi-core processor include two, four, eight, or greater numbers of processing cores. Alternatively, or in addition, the processor 704 may include one or more microprocessors configured in tandem via the bus 702 to enable independent execution of instructions, pipelining, and multithreading. The processor 704 may also be accompanied with one or more specialized components to perform certain processing functions and tasks such as one or more digital signal processors (DSP) 708, or one or more application-specific integrated circuits (ASIC) 710. A DSP 708 typically is configured to process real-world signals (e.g., sound) in real time independently of the processor 704. Similarly, an ASIC 710 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 704 and accompanying components have connectivity to the memory 706 via the bus 702. The memory 706 includes both dynamic memory (e.g., RAM, magnetic disk, writable optical disk, etc.) and static memory (e.g., ROM, CD-ROM, etc.) for storing executable instructions that when executed perform the inventive steps described herein to control the joystick 114 of the apparatus 112. The memory 706 also stores the data associated with or generated by the execution of the inventive steps.

FIG. 8 is a diagram of hardware that can be used to implement an embodiment. Computer system 800 is programmed (e.g., via computer program code or instructions) for controlling the joystick 114 of the apparatus 112 as described herein. The computer system 800 includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

The bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to controlling the joystick 114 of the apparatus 112. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations includes bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

The computer system 800 also includes a memory 804 coupled to bus 810. The memory 804, such as a random access memory (RAM) or other dynamic storage device, stores information including processor instructions for controlling the joystick 114 of the apparatus 112. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, which is not changed by the computer system 800. Some memory is composed of volatile storage that loses the information stored thereon when power is lost. Also coupled to the bus 810 is a non-volatile (persistent) storage device 808, such as a magnetic disk, optical disk, or flash card, for storing information, including instructions, which persists even when the computer system 800 is turned off or otherwise loses power.

Information, including instructions for controlling the joystick 114 of the apparatus 112, is provided to the bus 810 for use by the processor from an external input device 812, such as a keyboard containing alphanumeric keys operated by a human user, or a sensor. A sensor detects conditions in its vicinity and transforms those detections into physical expressions compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 818, is coupled to the bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 800 also includes one or more instances of a communications interface 820 coupled to bus 810. The communication interface 820 provides a one-way or two-way communication coupling to a variety of external devices that operate with their own processors, such as printers, scanners, and external disks. In general, the coupling is with a network link 822 that is connected to a local network 824 to which a variety of external devices with their own processors are connected. For example, the communication interface 820 may be a parallel port or a serial port or a universal serial bus (USB) port on a personal computer. In some embodiments, communications interface 820 is an integrated services digital network (ISDN) card or a digital subscriber line (DSL) card or a telephone modem that provides an information communication connection to a corresponding type of telephone line. In some embodiments, the communication interface 820 is a cable modem that converts signals on the bus 810 into signals for a communication connection over a coaxial cable or into optical signals for a communication connection over a fiber optic cable. As another example, communications interface 820 may be a local area network (LAN) card to provide a data communication connection to a compatible LAN, such as Ethernet. Wireless links may also be implemented. For wireless links, the communications interface 820 sends or receives or both sends and receives electrical, acoustic, or electromagnetic signals, including infrared and optical signals, which carry information streams, such as digital data. For example, in wireless handheld devices, such as mobile telephones like cell phones, the communications interface 820 includes a radio band electromagnetic transmitter and receiver called a radio transceiver. In certain embodiments, the communications interface 820 enables connection to the communication network 122.

The term computer-readable medium is used herein to refer to any medium that participates in providing information to processor 802, including instructions for execution. Such a medium may take many forms, including, but not limited to, non-volatile media, volatile media, and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 822 typically provides information communication using transmission media through one or more networks to other devices that use or process the information. For example, the network link 822 may provide a connection through local network 824 to a host computer 826 or to equipment 828 operated by an Internet Service Provider (ISP). ISP equipment 828 in turn provides data communication services through the public, world-wide packet-switching communication network of networks now commonly referred to as the Internet 830.

A computer called a server host 832 connected to the Internet hosts a process that provides a service in response to information received over the Internet. For example, server host 832 hosts a process that provides information representing video data for presentation at display 814. It is contemplated that the components of system can be deployed in various configurations within other computer systems, e.g., host computer 826 and server 832.

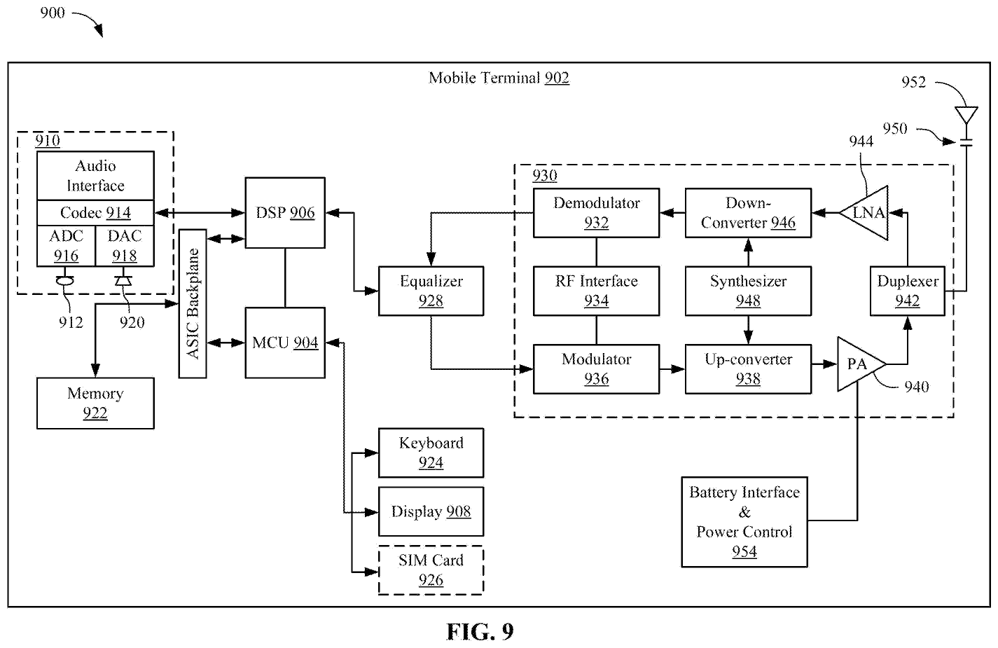

FIG. 9 is a diagram 900 of a mobile terminal 902 (e.g., handset, vehicle, or part thereof) that can be used to implement an embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 904, a Digital Signal Processor (DSP) 906, and a receiver/transmitter unit including a microphone gain control unit and a speaker gain control unit. A main display unit 908 provides a display to the user in support of various applications and mobile station functions that offer automatic contact matching. An audio function circuitry 910 includes a microphone 912 and microphone amplifier that amplifies the speech signal output from the microphone 912. The amplified speech signal output from the microphone 912 is fed to a coder/decoder (CODEC) 914.

A radio section 930 amplifies power and converts frequency in order to communicate with a base station, which is included in a mobile communication system, via antenna 952. The power amplifier (PA) 940 and the transmitter/modulation circuitry are operationally responsive to the MCU 904, with an output from the PA 940 coupled to the duplexer 942 or circulator or antenna switch, as known in the art. The PA 940 also couples to a battery interface and power control unit 954.

In use, a user of mobile terminal 902 speaks into the microphone 912 and his or her voice along with any detected background noise is converted into an analog voltage. The analog voltage is then converted into a digital signal through the Analog to Digital Converter (ADC) 916. The control unit 904 routes the digital signal into the DSP 906 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (Wi-Fi), satellite, and the like.

The encoded signals are then routed to an equalizer 928 for compensation of any frequency-dependent impairments that occur during transmission though the air such as phase and amplitude distortion. After equalizing the bit stream, the modulator 936 combines the signal with an RF signal generated in the RF interface 934. The modulator 936 generates a sine wave by way of frequency or phase modulation. In order to prepare the signal for transmission, an up-converter 938 combines the sine wave output from the modulator 936 with another sine wave generated by a synthesizer 948 to achieve the desired frequency of transmission. The signal is then sent through a PA 940 to increase the signal to an appropriate power level. In practical systems, the PA 940 acts as a variable gain amplifier whose gain is controlled by the DSP 906 from information received from a network base station. The signal is then filtered within the duplexer 942 and optionally sent to an antenna coupler 950 to match impedances to provide maximum power transfer. Finally, the signal is transmitted via antenna 952 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 902 are received via antenna 952 and immediately amplified by a low noise amplifier (LNA) 944. A down-converter 946 lowers the carrier frequency while the demodulator 932 strips away the RF leaving only a digital bit stream. The signal then goes through the equalizer 928 and is processed by the DSP 906. A Digital to Analog Converter (DAC) 918 converts the signal and the resulting output is transmitted to the user through the speaker 920, all under control of a Main Control Unit (MCU) 904—which can be implemented as a Central Processing Unit (CPU) (not shown).

The MCU 904 receives various signals including input signals from the keyboard 924. The keyboard 924 and/or the MCU 904 in combination with other user input components (e.g., the microphone 912) comprise a user interface circuitry for managing user input. The MCU 904 runs a user interface software to facilitate user control of at least some functions of the mobile terminal 902 for controlling the joystick 114 of the apparatus 112. The MCU 904 also delivers a display command and a switch command to the display 908 and to the speech output switch controller, respectively. Further, the MCU 904 exchanges information with the DSP 906 and can access an optionally incorporated SIM card 926 and a memory 922. In addition, the MCU 904 executes various control functions required of the station. The DSP 906 may, depending upon the implementation, perform any of a variety of conventional digital processing functions on the voice signals. Additionally, DSP 906 determines the background noise level of the local environment from the signals detected by microphone 912 and sets the gain of microphone 912 to a level selected to compensate for the natural tendency of the user of the mobile terminal 902.

The CODEC 914 includes the ADC 916 and DAC 918. The memory 922 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory 922 may be, but not limited to, a single memory, CD, DVD, ROM, RAM, EEPROM, optical storage, or any other non-volatile or non-transitory storage medium capable of storing digital data.

An optionally incorporated SIM card 926 carries, for instance, important information, such as the cellular phone number, the carrier supplying service, subscription details, and security information. The SIM card 926 serves primarily to identify the mobile terminal 902 on a radio network. The card 926 also contains a memory for storing a personal telephone number registry, text messages, and user specific mobile station settings.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A joystick control system comprising:
one or more manipulator-arms, each of the one or more manipulator-arms configured to engage with a joystick associated with an apparatus, wherein each of the one or more manipulator-arms is further configured to travel in an associated direction and cause a movement of the joystick along the associated direction;
an actuator mechanically coupled with each of the one or more manipulator-arms and configured to generate an action to cause each of the one or more manipulator-arms to travel in the associated direction; and
a controller communicatively coupled with the actuator and configured to generate an instruction to trigger the actuator to generate the action.

2. The joystick control system of claim 1, wherein the one or more manipulator-arms comprise:
a first pair of manipulator-arms, each of the first pair of manipulator-arms configured to travel in opposite directions, to cause a forward and a backward movement of the joystick.

3. The joystick control system of claim 2, wherein the one or more manipulator-arms further comprise:
a second pair of manipulator-arms, each of the second pair of manipulator-arms configured to travel in opposite directions and perpendicular to a direction of travel of each of the first pair of manipulator-arms, to cause a leftward and a rightward movement of the joystick.

4. The joystick control system of claim 1, wherein the actuator is an electric motor.

5. The joystick control system of claim 1, wherein the actuator is mechanically coupled with each of the one or more manipulator-arms via an associated gear assembly.

6. The joystick control system of claim 5, wherein the gear assembly comprises:
a rack configured to couple with an associated manipulator-arm of the one or more manipulator-arms; and
a pinion configured to couple with the actuator and further configured to engage with the rack,
wherein the action generated by the actuator is to cause a movement of the pinion, and
wherein the movement of the pinion is transferred to the rack and subsequently to the associated manipulator-arm, to cause the associated manipulator-arm to travel in the associated direction.

7. The joystick control system of claim 5, wherein the controller generates the instruction to trigger the actuator, based on a signal received from an electroencephalography (EEG) device contacting a user.

8. The joystick control system of claim 7, further comprises:
a display screen communicatively coupled to the controller and configured to display a menu of a plurality of selectable options to present a visual stimuli to the user,
wherein a response to the stimuli corresponding to a selectable option of the plurality of selectable options is detected by the EEG device, and
wherein the EEG device generates the signal based on the response to the stimuli.

9. The joystick control system of claim 8, wherein the apparatus is a motorized wheelchair.

10. The joystick control system of claim 9, further comprising:
a remote sensing device communicatively coupled with the controller,
wherein the remote sensing device is configured to dynamically detect a position of the motorized wheelchair relative to surroundings of the motorized wheelchair and generate sensor data corresponding to the position of the motorized wheelchair relative to the surroundings of the motorized wheelchair, and
wherein the controller generates the instruction to trigger the actuator, further based on the sensor data, to facilitate autonomous navigation for the motorized wheelchair.

11. The joystick control system of claim 10, wherein the controller generates the instruction to trigger the actuator based on a spatial map for the surroundings of the motorized wheelchair, to facilitate autonomous navigation for the motorized wheelchair, wherein the spatial map is predefined.

12. The joystick control system of claim 10, wherein the remote sensing device comprises a Light Detection and Ranging (LiDAR) sensor.

13. The joystick control system of claim 9, further comprises:
an extendable arm configured to be positioned on a front side of the motorized wheelchair and an arm rest section of the motorized wheelchair,
wherein the display screen is positioned on the curved extendable arm.

14. The joystick control system of claim 1, wherein the joystick control system is configured to retro-fit on the joystick associated with the apparatus.

15. A method of controlling a joystick of an apparatus, the method comprising:
transmitting, by a controller, an instruction to an actuator to trigger the actuator to generate an action, the controller being communicatively coupled with the actuator,
wherein the actuator is mechanically coupled with each of one or more manipulator-arms,
wherein each of the one or more manipulator-arms is configured to engage with the joystick associated with the apparatus, and
wherein the action generated by the actuator is to cause each of the one or more manipulator-arms to travel in an associated direction and cause the movement of the joystick along the associated direction.

16. The method of claim 15 further comprising:
receiving, by the controller, a signal received from an electroencephalography (EEG) device contacting a user; and
generating, by the controller, the instruction to trigger the actuator, based on the signal received from the EEG device.

17. The method of claim 16 further comprising:
displaying, by the controller, via a display screen communicatively coupled to the controller, a menu of a plurality of selectable options to present a visual stimuli to the user,
wherein a response to the stimuli corresponding to a selectable option of the plurality of selectable options is detected by the EEG device, and
wherein the EEG device generates the signal based on the response to the stimuli.

18. The method of claim 17, wherein the instruction to trigger the actuator is generated, further based on sensor data obtained from a remote sensing device communicatively coupled with the controller and the joystick of a motorized wheelchair,
wherein the remote sensing device is configured to dynamically detect a position of the motorized wheelchair relative to surroundings of the motorized wheelchair and generate the sensor data corresponding to the position of the motorized wheelchair relative to the surroundings of the motorized wheelchair to facilitate autonomous navigation for the motorized wheelchair.

19. The method of claim 17, wherein the instruction to trigger the actuator is generated based on a spatial map for the surroundings of the motorized wheelchair to facilitate autonomous navigation for the motorized wheelchair, wherein the spatial map is predefined.

20. A non-transitory computer-readable storage medium having computer program code instructions stored therein, the computer program code instructions, when executed by at least one processor, cause the at least one processor to:
transmit an instruction to an actuator to trigger the actuator to generate an action, the controller being communicatively coupled with the actuator,
wherein the actuator is mechanically coupled with each of one or more manipulator-arms,
wherein each of the one or more manipulator-arms is configured to engage with the joystick associated with the apparatus, and
wherein the action generated by the actuator is to cause each of the one or more manipulator-arms to travel in an associated direction and cause the movement of the joystick along the associated direction.
